(19) United States
(12) Patent Application Publication
(10) Pub. No.: US 2024/0268256 A1
(43) Pub. Date: Aug. 15, 2024

(54) Potato Planter

(71) Applicant: Allan Equipment Manufacturing Ltd., York (CA)

(72) Inventors: Daniel VAN SCHALKWYK, York (CA); Layton Graham, Herington (CA)

(21) Appl. No.: 18/290,774

(22) PCT Filed: Jul. 20, 2022
(86) PCT No.: PCT/CA2022/051132

§ 371 Date: Jan. 20, 2024

(30) Foreign Application Priority Data
Jul. 20, 2021 (US) 63223967

(51) Int. Cl. A01C 9/08; A01C 7/20

(52) U.S. Cl. CPC A01C 9/08; A01C 7/20

(57) ABSTRACT

In one aspect there is provided a planting unit for singulating a plurality of seeds, said planting unit comprising a seed holder, a seed discharge, at least one drive unit and a seed singulator. The seed singulator further comprises a seed singulating ledge and an excess seed ejector to eject any excess seeds from the seed singulating ledge onto the seed holder.

### FIELD OF THE INVENTION

This invention relates generally to seed planting and singulating machines. More particularly, the invention relates to an improved potato seed planter that is adapted to rapidly singulate and dispense seeds at a controlled rate.

### BACKGROUND OF THE INVENTION

The background information discussed below is presented to better illustrate the novelty and usefulness of the present invention. This background information is not admitted prior art.

It is well recognized that proper and uniform spacing of seeds in a furrow is essential to maximizing crop yield. The first step in achieving uniform spacing is to accurately dispense one seed and one seed only at the proper timing. This may be referred to as seed “singulation” and/or to “singulate” seeds. A singulator attempts to separate one seed at a time from a plurality of seeds that are present in a seed bowl, seed hopper or the like, and then directs that separated seed down a seed path or tube to be presented for planting (such as in a furrow).

In the potato planting industry, seed potatoes are commonly cut into pieces prior to planting because all that is required for a seed is a piece of the seed potato that contains a potato eye. Sometimes whole potatoes are planted. Disadvantageously, because the seed potatoes are often cut into various shapes and sizes, and because both cut and whole potatoes are not perfectly round and do not have a uniform shape, potato seeds are difficult to singulate.

Conventional potato seed planters still suffer from a number of disadvantages when singulating seed potatoes. For example conventional “belted cup” planters are constrained by speed, where if the planter goes too fast and requires more rapid singulation, the seeds fall out of the cups. When the belt in such belted cup planter goes too fast, it misses picking up the seeds with each cup, and the seeds typically cavitate and bridge within the seed bowl that feeds the belted singulator device.

Additionally, the potato seed profile may differ from year to year. This may be done by cutting the potatoes to different sizes, e.g. each seed is half (½) of a potato or a quarter (¼) of a potato. When using the conventional belted cup planters, farmers will typically change out the individual cups in their planters to cups that are appropriately sized for a particular batch of seed potatoes. This is laborious and creates additional work for potato farmers.

Therefore, what is needed is a potato planter and potato seed singulator that does not suffer from these disadvantages.

### SUMMARY OF THE INVENTION

In an embodiment of the invention, there is provided a planting unit for singulating a plurality of seeds, said planting unit comprising a seed holder, a seed discharge, at least one drive unit, and a seed singulator. The seed singulator further comprises a seed singulating ledge and an excess seed ejector to eject any excess seeds from the seed singulating ledge onto the seed holder.

### BRIEF DESCRIPTION OF THE DRAWINGS

Referring to the drawings, several aspects of the present invention are illustrated by way of example, and not by way of limitation, in detail in the figures, wherein:

FIG. 1a is a perspective view of an improved potato seed planter in accordance with a preferred embodiment of the present invention;

FIGS. 1b-1c are other perspective views of the potato seed planter of FIG. 1a;

FIG. 1d is a close-up perspective view a row of the four rows of planting units of the potato seed planter of FIG. 1a;

FIG. 2a a perspective view of a planting unit;

FIG. 2b is another perspective view of the planting unit of FIG. 2a;

FIG. 3a a top view of the planting unit of FIG. 2a;

FIG. 3b is a top perspective view of the planting unit of FIG. 2a;

FIG. 4 is a bottom view of the planting unit of FIG. 2a;

FIG. 5 is a front view of the planting unit of FIG. 2a;

FIG. 6 is a rear view of the planting unit of FIG. 2a;

FIG. 7 is a left side view of the planting unit of FIG. 2a;

FIG. 8 is a right side view of the planting unit of FIG. 2a;

FIGS. 9a and 9b are perspective views of another embodiment of a planting unit;

FIGS. 10a-10h are perspective views of the planting unit of the embodiment of FIG. 9a, illustrating a sequence of potato seeds being singulated;

FIG. 11 is a sectioned perspective view of the planting unit of FIG. 2a taken along line A-A in FIG. 3a;

FIGS. 12a-12b are sectioned perspective views of the planting unit of FIG. 2a taken along line B-B in FIG. 3a;

FIG. 13 is a top perspective view of an embodiment of a planting unit and also showing a potato seed sensor;

FIG. 14 is a top perspective view of an embodiment of an inner circular wall 52 with flights 58 mounted thereon;

FIG. 15 is a top perspective view of another embodiment of the flights; and

FIGS. 16a and 16b are perspective views of another embodiment of the planting unit, utilizing the embodiment of the flights of FIG. 15.

### DEFINITION SECTION

Horizontal plane, as used herein, refers to a plane that is horizontal at a given point if it is perpendicular to the gradient of the gravity field at that point, in other words, apparent gravity is what makes a plumb bob hang perpendicular to the plane at that point. In other words a horizontal plane in the plane that is perpendicular to the line that passes through the center of the Earth.

Vertical plane, as used herein, refers in astronomy, geography, geometry, and related sciences and contexts, to a direction passing by a given point if it is locally aligned with the gradient of the Earth's gravity field, i.e., with the direction of the gravitational force (per unit mass, i.e. gravitational acceleration vector) at that point.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

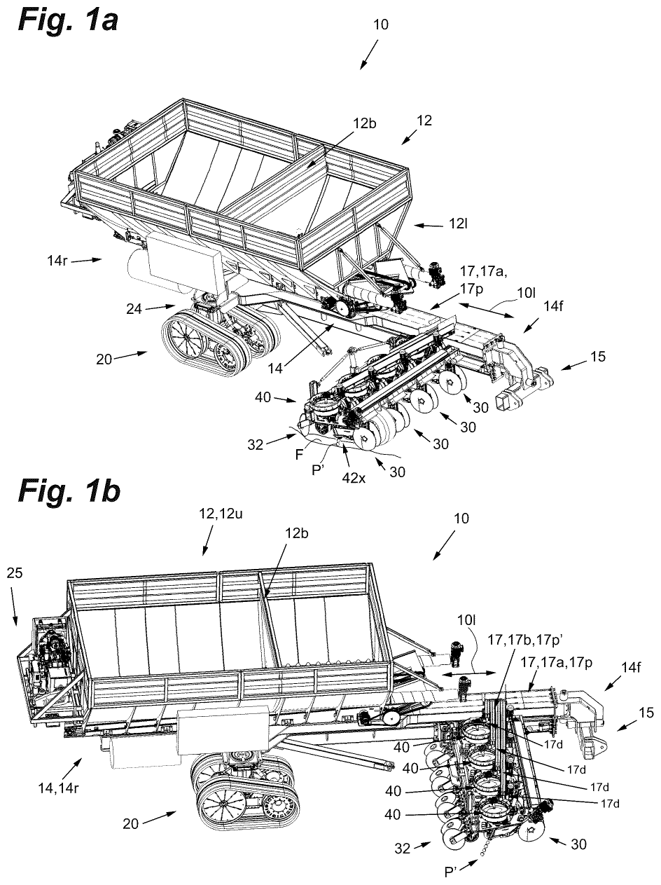

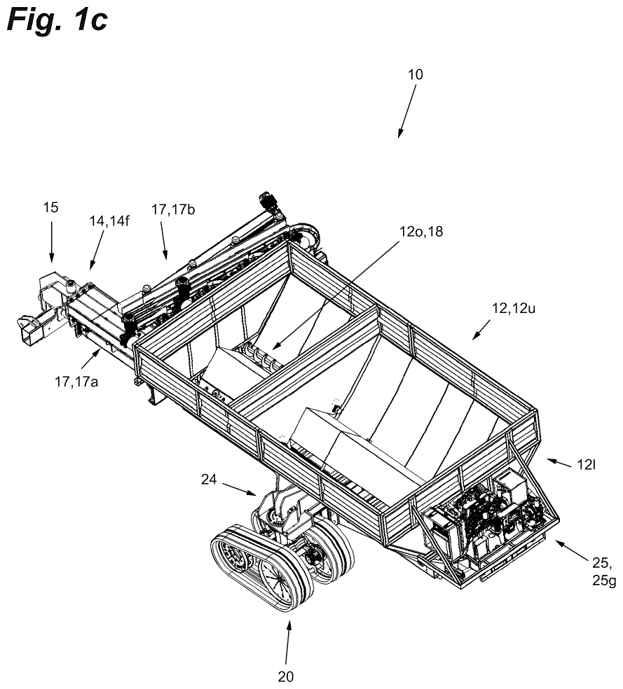

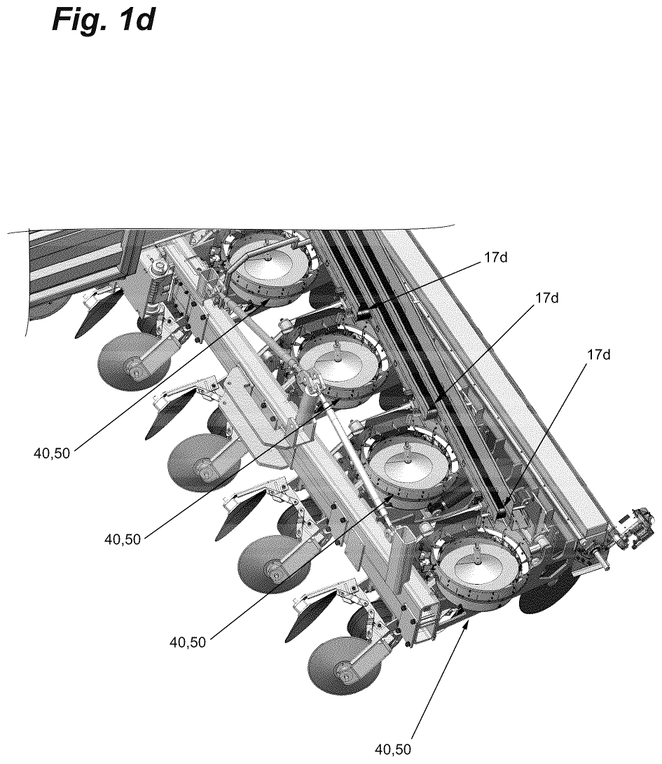

A first embodiment of the potato seed planter 10 of the present invention is shown in FIGS. 1a-1c. While the present invention involves an improved potato seed planter, the principles of the present invention are not limited to potato seed planters. It will be understood that, in light of the present disclosure, the seed planter disclosed herein can be used in connection with other types of seeds, bulbs, onions, flowers, and the like. Additionally, to assist in the description of the potato seed planter, words such as top, bottom, front, rear, right and left are used to describe the accompanying figures. It will be appreciated, however, that the present invention can be located in a variety of desired positions and angles, and that the various components can be arranged in other suitable configurations. A detailed description of the improved potato seed planter now follows.

As best seen in FIGS. 1a-1c, the potato seed planter 10 comprises a seed hopper 12 for receiving potato seeds P, and a frame 14 for supporting the hopper 12. The frame 14 may have a front frame end 14f and a rear frame end 14r. One or more continuous tracks or wheels 20 are preferably attached to the frame 14. Various linking members 24 may be used to attach the continuous tracks 20 to the frame 14. The continuous tracks 20 are used to drive the potato seed planter 10 and transport it to and from the fields to be planted in a conventional manner.

The potato seed planter 10 preferably includes a conventional drive or power generating system 25 for powering one or more components of the planter 10. One skilled in the art will appreciate that the power generating system 25 of the potato seed planter 10 may be an engine driven generator 25g or a hydraulic-based power system. The potato seed planter 10 preferably comprises a hitch link 15 at the front frame end 14f for connecting the potato seed planter 10 to a tractor (not shown) in a conventional manner.

The potato seed planter 10 is designed to be pulled behind a tractor (not shown), and the tractor may also provide power to the planter 10. As known in the art, tractors typically provide hydraulic or mechanical power to a towed device such as a planter 10. The potato seed planter 10 can also be powered by the power generating system 25, and/or by hydraulic or mechanical power from the tractor, or it can be powered from any other suitable source.

As best seen in FIGS. 1a-1c, at least one planting unit 40 is attached or linked to the frame 14 in a conventional manner, preferably between the hitch link 15 and the seed hopper 12. A plow or furrow opener 30 is preferably provided for each planting unit 40 to create a furrow F to receive a potato seed P, and a furrow closing member or disc 32 is preferably provided for each planting unit 40 to cover the seeds P with soil and close the furrow. It will be appreciated that the furrow opener 30 and furrow closer 32 are adjustable in a conventional manner to create furrows of the desired size, spacing, depth, and the like.

The planting unit 40 dispenses individual potato seeds P supplied by the seed hopper 12 into a furrow F created by the furrower opener 30 at a controlled rate, accurately dispensing one seed and one seed only at the proper timing. The potato seed planter 10 may include any suitable number of planting units 40 and associated components to plant multiple rows at one time. Thus, although the accompanying figures illustrate the potato seed planter 10 as a four-row planter, it can plant any desirable number of rows, e.g. such as from one to twelve rows or more. One skilled in the art will understand that while the preferred embodiments of the potato seed planter 10 illustrate the various components of the planter 10 in specific locations, these components may be arranged in any suitable locations and configurations.

As best seen in FIGS. 1a-1c, the seed hoppers 12 are sized and configured to receive numerous potato seeds P that are to be planted. As is conventional, the seed hopper 12 includes generally upright upper walls 12u, angled lower walls 121, and one or more openings 120 at the hopper's bottom. A conventional auger 18 may be provided below or adjacent the one or more openings 120, to assist with the controlled discharge of potato seeds P from the seed hopper 12 in a conventional manner. The seed hopper 12 may also contain baffles 12b and/or shaker members (not shown) to agitate the seeds P. A conveyor system 17 is preferably provided to carry the seeds P exiting out from the hopper's bottom opening 120 to one or more planting units 40. For example, a first conveyor 17a may carry seeds P from the hopper 12 a first distance along a first path 17p, which may be substantially parallel to the longitudinal axis 101 of the planter 10. This may be a conventional conveyor.

One or more secondary conveyors 17b may also be provided to carry seeds P from the first conveyor 17a a second distance to the one or more planting units 40 along a second path 17p′. These may also be conventional conveyors. The secondary path 17p′ which may be substantially perpendicular to the first path 17p, such as in an embodiment of a planter 10 where a plurality of planting units 40 are provided in a row that is substantially perpendicular to the planter's longitudinal axis 101; as can be seen in FIGS. 1a and 1b. The baffles and any shaker members are used to keep the pieces of potato seed P separated and agitated while in the hopper 12, but they are not required.

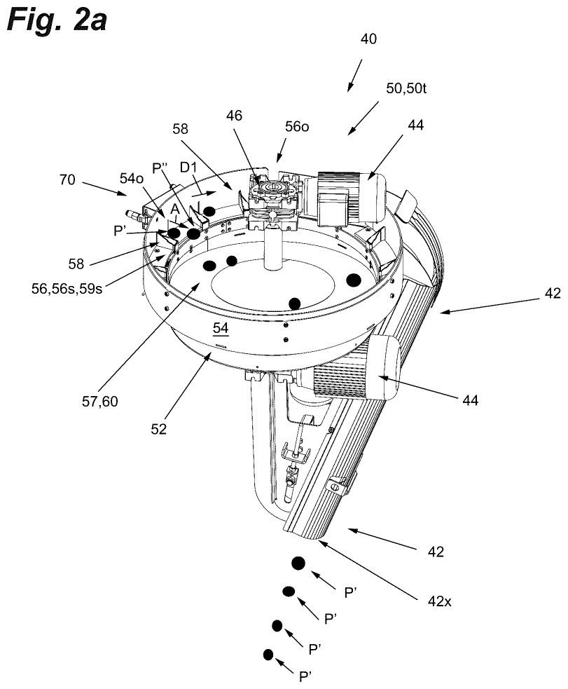

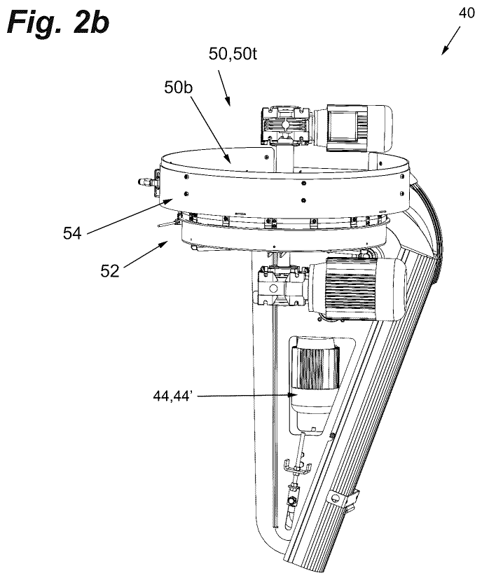

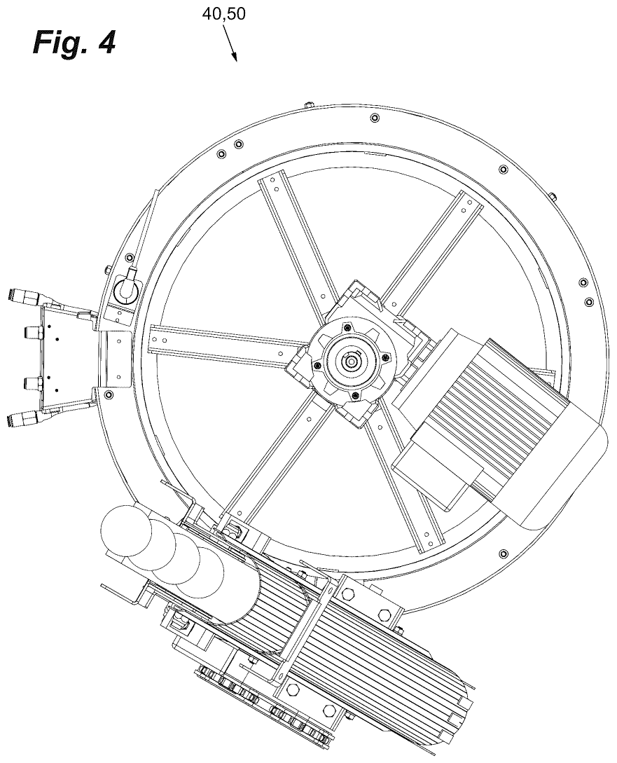

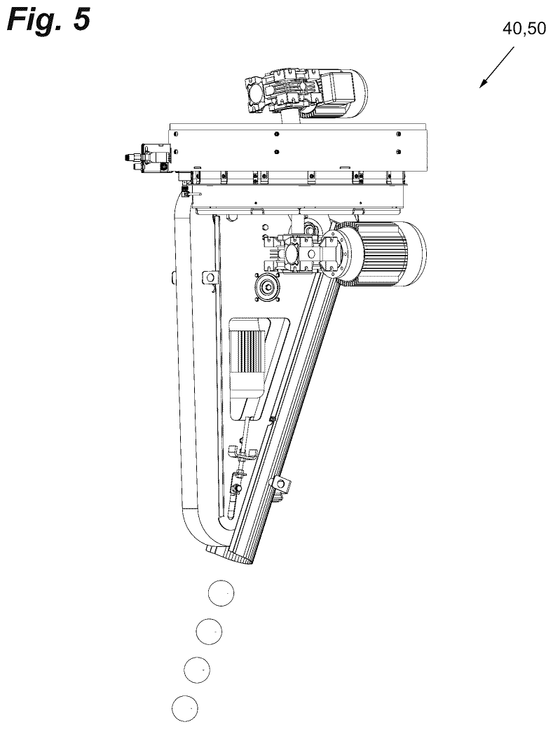

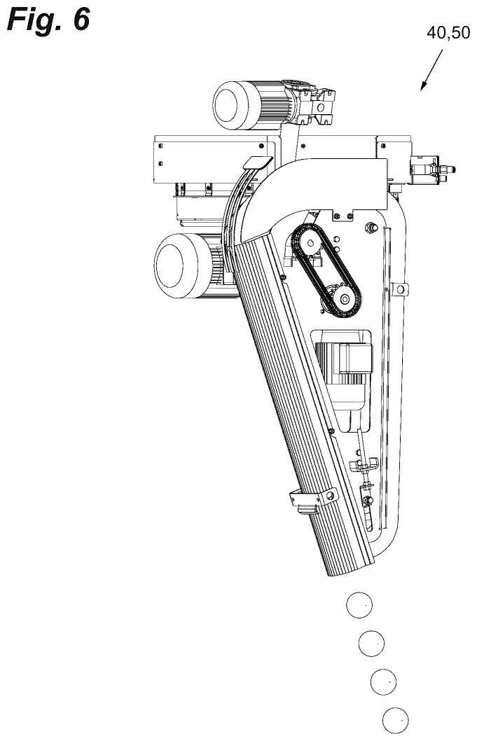

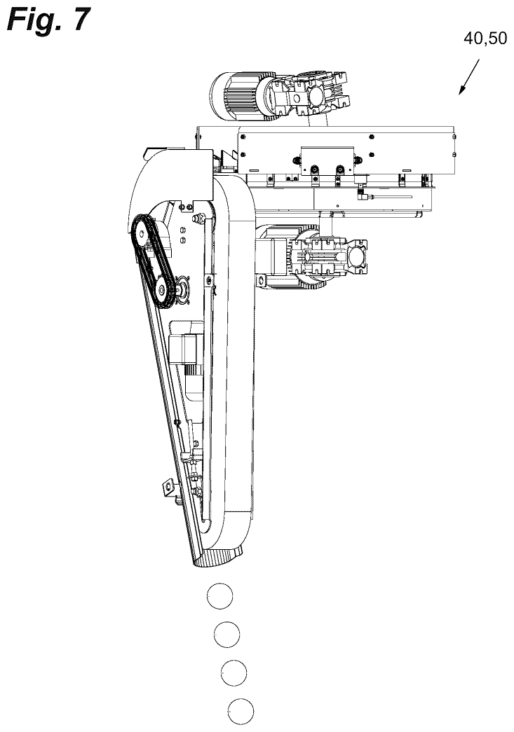

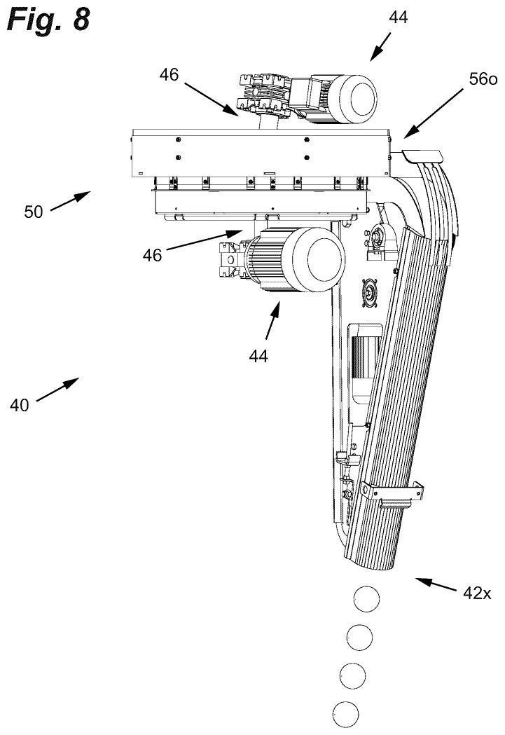

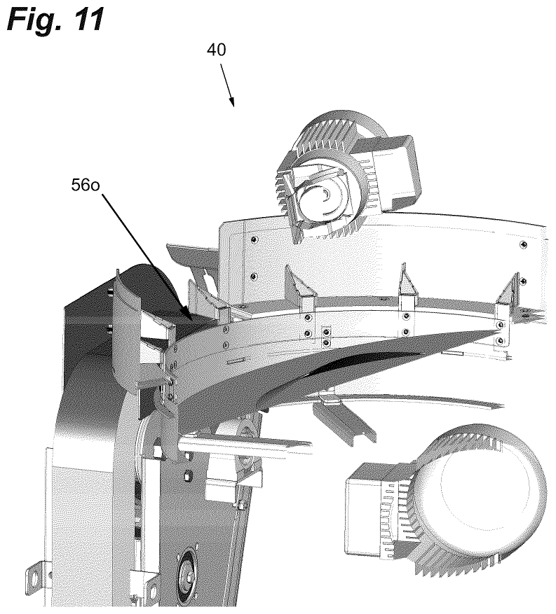

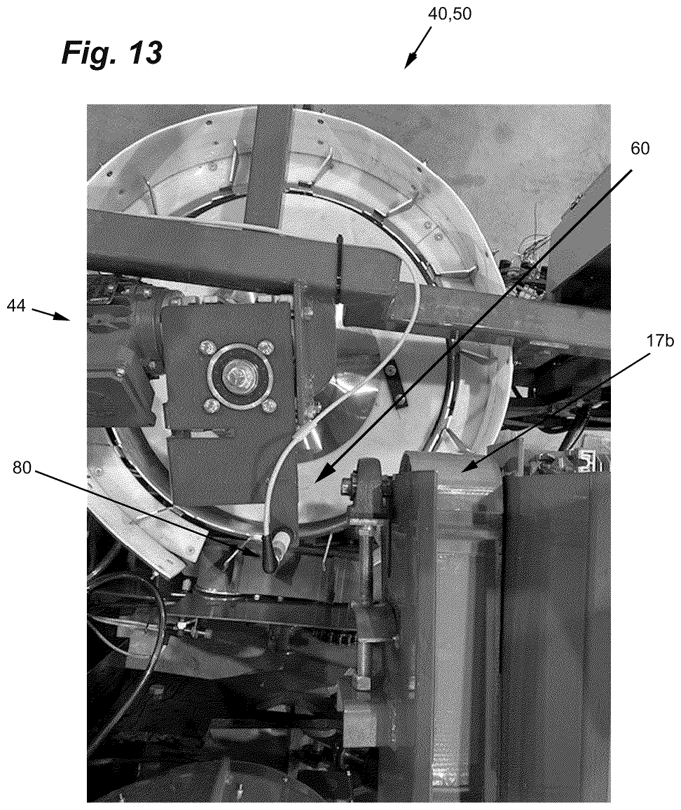

As seen in FIGS. 2a-13, each planting unit 40 preferably comprises a seed discharge or seed chute 42, one or more drive units 44, one or more drive linkages 46 and a singulating mechanism or seed singulator 50. The seed singulator 50 separates individual potato seeds P from a plurality of such seeds PP and delivers them to the seed discharge 42 for subsequent planting in the ground at a desired and uniform spacing. The drive units 44 preferably provide rotary drive and other actuating forces to operate the planting unit 40 and its various components. The drive units 44 may be electrical or hydraulic motors and may be powered by the power generating system 25 in a conventional manner. The linkages 46 may connect the drive units 44 to the various components of the planting unit 40 in a conventional manner and may further be provided with gearing mechanisms to provide these components with sufficient mechanical force (including rotational force) to allow for efficient operation of the planting unit 40 and the singulator 50.

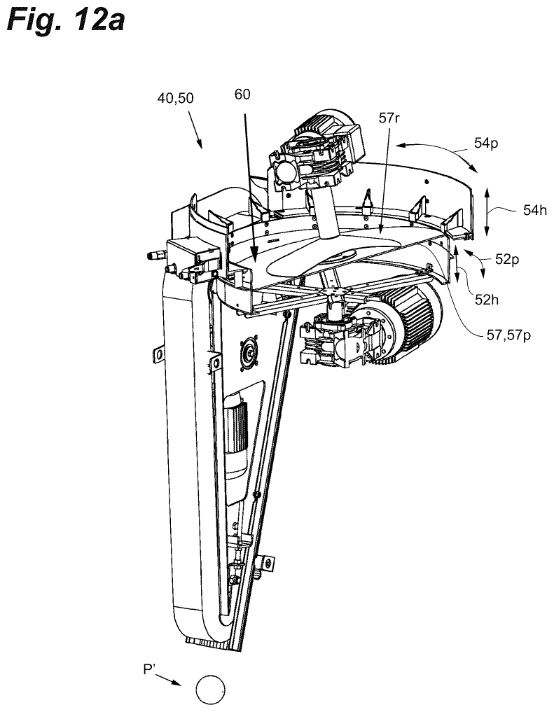

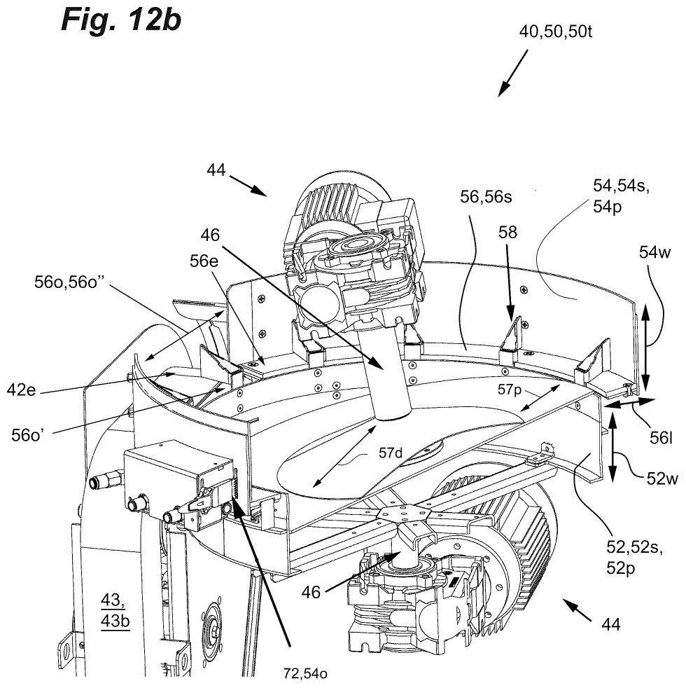

Referring to FIGS. 2a, 2b, 12a and 12b, the seed singulator 50 preferably features an open top 50t and a stepped bowl-like configuration having a lower inner circular wall 52, an upper outer circular wall 54 and a seed singulating ledge, surface or step 56 therebetween; see FIG. 12b. A substantially circular seed holder or bottom support 57 is preferably provided within the lower inner circular wall 52. The inner and outer circular walls 52, 54 each preferably comprise an inner seed retention surface, identified as 52s and 54s respectively, and with each such surface 52s, 54s having a wall axis 52w, 54w; see FIG. 12b. The seed singulating ledge 56 preferably comprises a seed support surface 56s having a ledge axis 561.

The inner and outer circular walls 52, 54 and the seed singulation ledge 56 are preferably circular planar members as shown in the figures. The inner and outer circular walls 52, 54 each preferably form a circular perimeter 52p, 54p having a respective wall height 52h,54h; see FIG. 12a. During operation of the planter 10, the wall axis 52w, 54w of the seed retention surfaces 52s, 54s are preferably maintained in a manner that is substantially along the vertical plane, while the ledge axis 561 is preferably maintained substantially along the horizontal plane. Accordingly, during operation, gravity will encourage any potato seeds P to be supported on or by the singuating ledge 56.

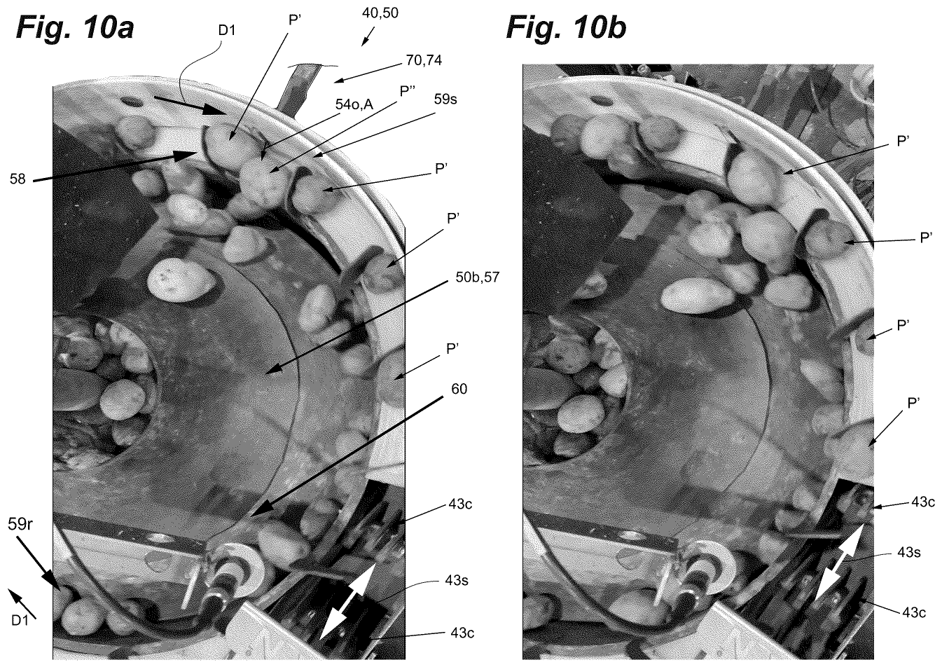

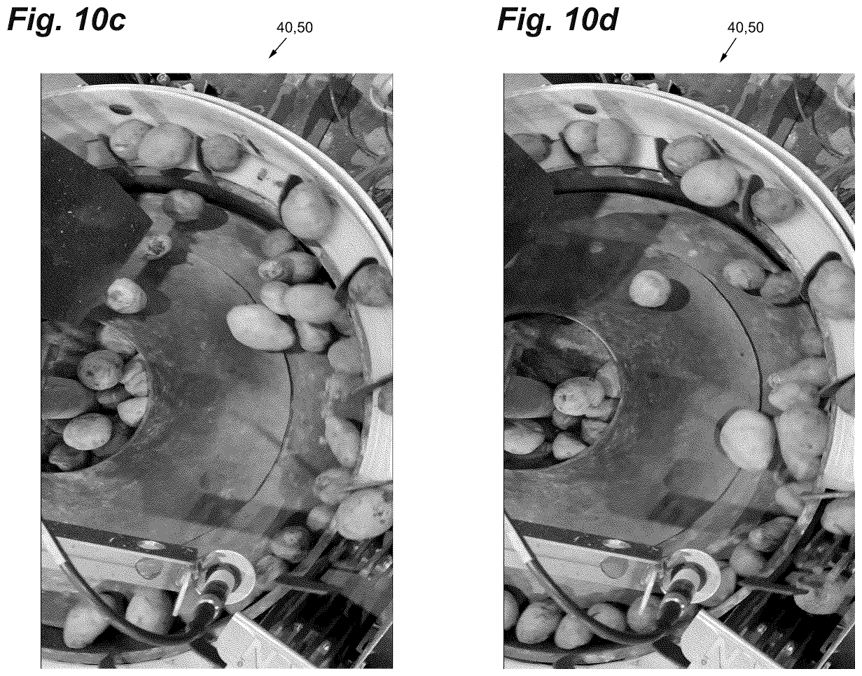

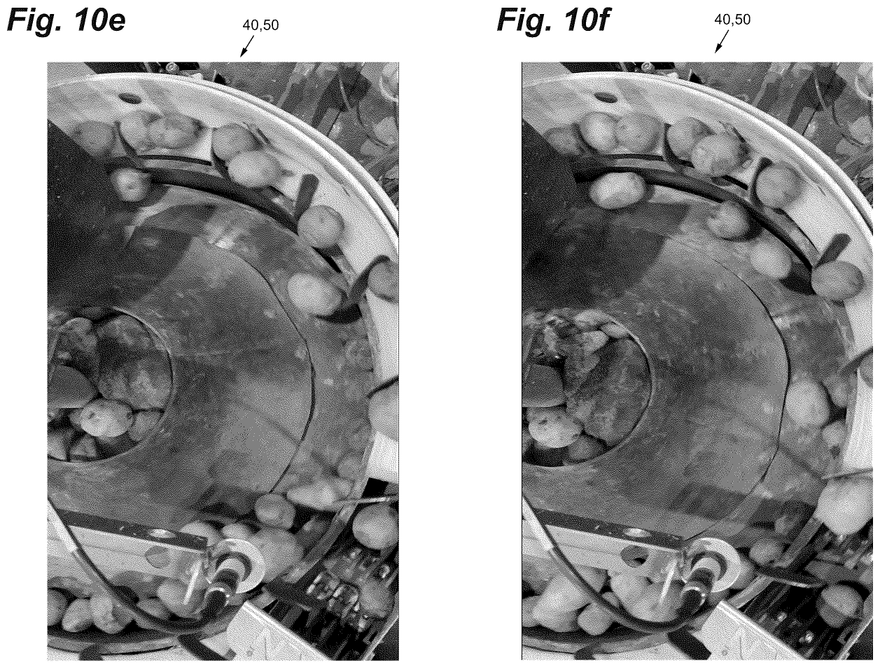

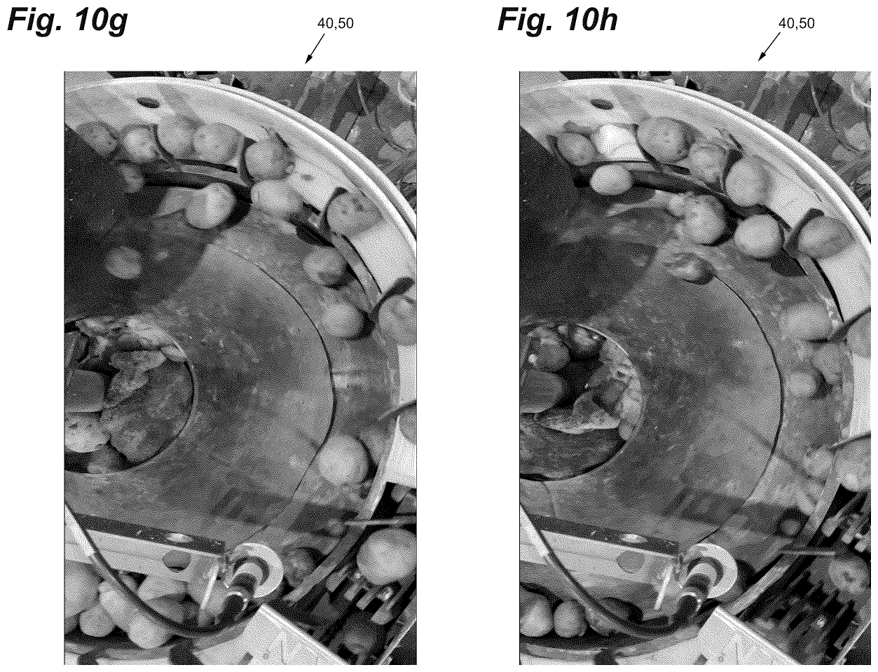

The lower inner circular wall 52, the upper outer circular wall 54, the seed singulating ledge 56 and the seed holder 57 cooperate to provide the singulator with its stepped bowl-like configuration and together they form a seed singulation area or seed bowl 50b; see FIG. 2b. During operation of the planting unit 40 the seed bowl 50b contains or holds a plurality of potato seeds PP therein; e.g. see FIGS. 10a-10h. The seed holder 57 substantially seals the bottom of the seed bowl 50b and prevents the plurality of seeds PP from exiting downward out of the seed bowl 50b. The seed retention surfaces 52s, 54s act as bowl walls, having sufficient wall heights 52h, 54h to prevent the plurality of seeds PP from exiting radially out of the seed bowl 50b past their respective circular perimeters 52p, 54p; except for as specifically noted below to feed or exit singulated potato seeds from the singulator 50 to the seed discharge 42.

While each of the lower inner circular wall 52, the upper outer circular wall 54 and the bottom seed holder 57 are separate components, which each may move or rotate relative to each other, they are dimensioned with sufficiently close tolerances and spacing so that they can cooperate as noted above to form the seed bowl 50b and contain seeds PP therewithin. Advantageously, the seed singulation area or seed bowl 50b will hold these plurality of seeds PP while the seed singulator 50 separates individual potato seeds P therefrom and delivers them to the seed discharge 42.

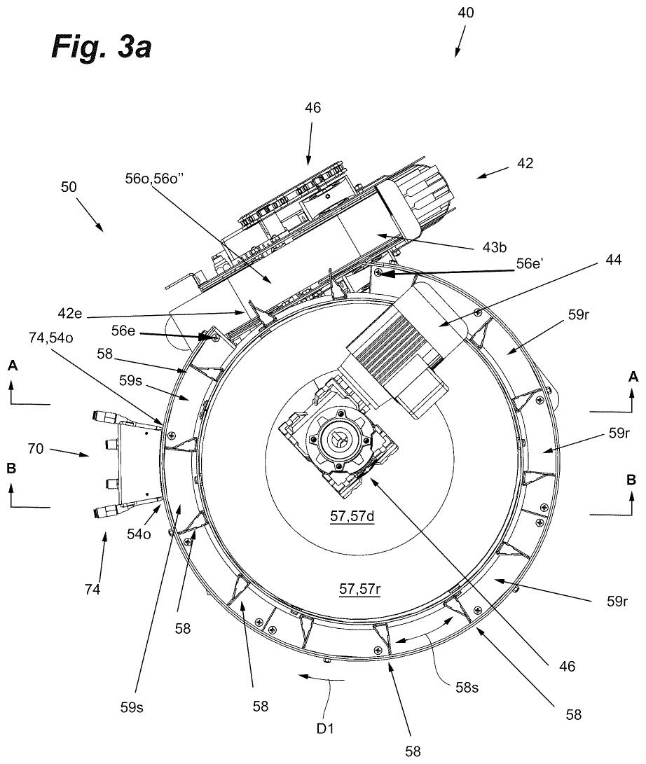

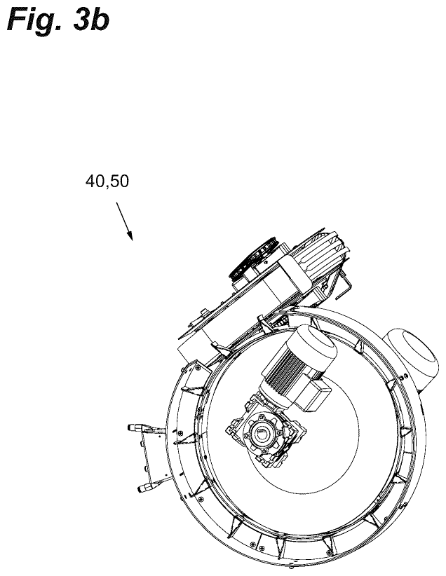

In a preferred embodiment the seed singulating ledge 56 is an annulus sector (circular ring sector) positioned between the outer and inner circular perimeters 52p, 54p; i.e. the ledge 56 does not form a complete annular path between said perimeters 52p, 54p. Instead, a seed discharge opening 560 is provided below and/or adjacent ends 56e, 56e′ of the annular sector ledge 56; see FIGS. 3a and 12b.

The seed discharge opening 560 may be below and/or radially outward from said perimeters 52p, 54p. In the embodiment of FIGS. 2a-8 and 11-12b, the seed discharge opening 560 features both a first component 560′ that is below the level of ledge 56 and a second component 560″ comprising an opening or passage in the upper outer circular wall 54; see FIG. 12b.

The seed singulating ledge 56 may also be divided into a seed receiving area 59r and a seed singulation area 59s; see FIG. 10a. During operation of the planting unit 40 the seed receiving area 59r will generally receive a plurality of potatoes PP from either the secondary conveyor 17b or from the seed holder 57. Preferably, the seed singulation ledge 56 is attached to, or integral with, the outer circular wall 54; and both the outer circular wall 54 and the ledge 56 are mounted to, and stationery with respect to, the planter's frame 14; e.g. via one or more of the conveyor system 17, such as a secondary conveyor 17b.

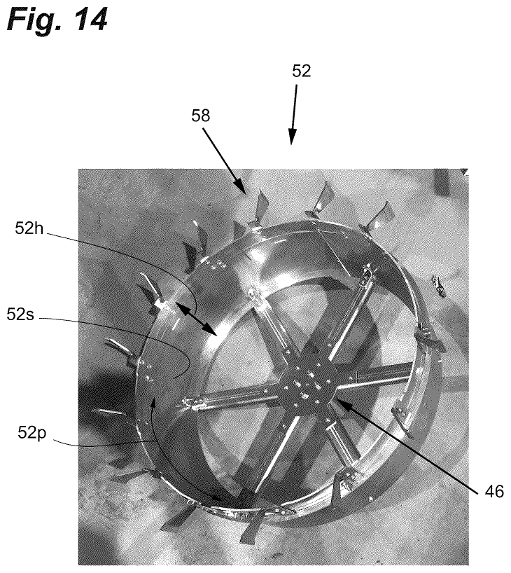

The seed singulator 50 preferably comprises a plurality of flights 58 positioned above the seed singulating ledge 56. These flights 58 may be mounted on the inner circular wall 52 which can move (rotate) relative to the outer circular wall 54 and ledge 56. One embodiment of the inner circular wall 52, with flights 58 mounted thereon, is shown in FIG. 14. Preferably, both the inner circular wall 52 and the flights 58 are actuated or driven (e.g. in a rotary fashion) along the first direction D1 by one or more of the drive units 44 and associated linkage 46 in a conventional manner.

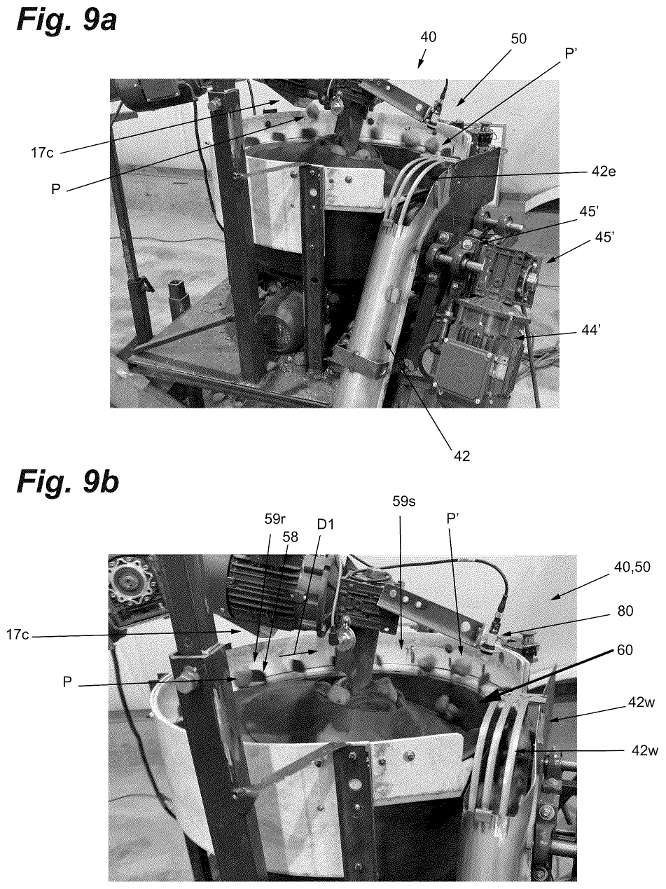

During operation the rotating flights 58 function to advance potato seeds P that are present on said ledge 56 in a first direction D1 at a first speed from the seed receiving area 59r to the seed singulation area 59s, where any plurality of seeds PP between a corresponding set of flights 58 are then singulated, as further described below. In this embodiment it is the flights 58 which advance any potato seeds P along the ledge 56 radially (i.e. seeds being contained on ledge 56 by upper outer circular wall 54) in the first direction D1 (e.g. see FIG. 10a). The flights 58, as supported by the inner circular wall 52, will continue rotating in the first direction D1 and pass over and/or beside the seed discharge opening 560. Any singulated seeds P′ pushed or advanced by the flights 58 will then preferably exit out of the opening 560 and into an entrance 42e of the seed discharge 42; although some may, however, fall back into the seed bowl 50b to rest on the seed holder 57. Preferably, the seed discharge 42 further comprises one or more conventional walls or barriers 42w barrier to assist with directing any singulated seeds P′ exiting the singulator 50 down into the chute 42 (see FIG. 9).

For example, any seeds P pushed or advanced by the flights 58 along a radial path on the ledge 56, along the first direction D1 from the seed receiving area 59r to the seed singulation area 59s, will be singulated at said seed singlation area 59s (as further described below) and then preferably exit out of the opening 560 and into the entrance 42e of the seed discharge 42, such as due to the force of gravity (e.g. through the first component 560′) or in a centrifugal-like manner (through the second component 560″) or via a combination thereof.

The seed chute is preferably a hollow tubular member having an exit 42x to discharge the singulated potato seeds P′. Preferably the exit 42x of each planting unit's seed chute 42 is positioned and directed behind the unit's respective furrow opener 30 and in front of the unit's respective furrow closer 32, so that singulated seeds P′ exiting therefrom will be placed into a furrow F created in the ground by the planter 10, preferably in a singulated and spaced-apart manner (see FIG. 1a).

Preferably, the seed chute 42 further comprises a seed delivery conveyor 43, which may comprise an endless or continuous chain or belt 43b. Continuous belt 43b preferably carries a plurality of spaced apart seed carrying members, flights or cups 43c to maintain the singulated seeds P′ substantially in their singulated condition while travelling down the chute 42 towards the exit 42e. In a preferred embodiment, the spacing 43s between each set of the seed carrying flights or cups 43c is 5.75 inch spacing. The delivery conveyor 43 is preferably placed within the within the chute's hollow interior, and the individual seed carrying members 43c are dimensioned to maintain a desired potato seed singulation distance (between individually singulated seeds P′; e.g. maintain a substantially 5.75 inch spacing between individually singulated seeds).

During operations a plurality of seeds PP are provided to a seed deposit area 60 within the singulator 50 of each planting units 40 by the one or more secondary conveyors 17b; e.g. seeds PP conveyed from the seed hopper 12. The seed deposit area 60 may be an area within the inner circular wall 52 and above the seed holder 57. The plurality of seeds PP may simply discharge from the secondary conveyors 17b into seed deposit area 60 by dropping down at the secondary conveyor's head or discharge end 17d (the discharge ends 17d preferably placed above of their respective planting unit 40 and/or singulator 50; see FIGS. 1b and 1d). A conveyor discharge chute 17c may be provided to guide the plurality of potato seeds P from the discharge end 17d into the deposit area 60, preferably above the seed receiving area 59r (see FIGS. 9a-9b).

Preferably the seed holder 57 further comprises a seed receiving surface 57r having a substantially circular perimeter 57p. The seed receiving surface 57r preferably comprises a central dome or frustum-like portion 57d and a peripheral flanged or disc-like periphery 57f. Seed holder 57 preferably rotates relative to the outer circular wall 54, the ledge 56 and the inner circular wall 52 bearing the flights 58; preferably driven by one or more of the drive units 44 via associated linkage 46 in a conventional manner. Seed holder preferably rotates in the first direction, but at a second speed which is preferably faster than the first speed of the inner circular wall 52 and its flights 58. More preferably, the seed holder 57 is angled slightly relative to the inner and outer circular walls 52, 54 and the ledge 56; e.g. 15 degrees, see FIG. 12b. As such, this angle allows a portion of the seed holder's flanged periphery 57f to come up to the ledge 56, while at the same time creates another portion of the seed holder's flanged periphery to be near the bottom of the inner circular wall 52 forming the seed deposit area 60. This angled aspect of the seed holder 57, wherein the lower part of holder 57 is generally adjacent the seed singulation area 59s and the raised part of the holder 57 is generally adjacent the seed receiving area 59r, functions to drive seeds PP into said seed receiving area 59r while discouraging seeds PP from entering the seed singulation area 59s directly from the holder 57 (instead seed PP are driven by flights 58 in a radial manner on the seed singulating ledge 56 along the first direction D1 from seed receiving area 59r to seed singulation area 59s). Advantageously, this enhances seed singulation (at seed singulation area 59s) because any excess seeds PP (on ledge 56) can easily be driven back onto the holder 57.

The singulator 50 preferably further comprises an excess seed ejector 70 to eject excess seeds P″ from between the flights 58 on the ledge 56 as they pass through the seed singulation area 59s, and thereby leaving only a single singulated seed P′ adjacent its corresponding flight 58. The seed ejector 70 is preferably a pneumatic seed ejector, capable of providing a burst of air A of suitable force to push excess seeds P″ back into the seed holder 57; e.g. see FIG. 10a. A conventional air source (not shown) may be provided to the pneumatic seed ejector 70, and an air nozzle 74 may be directed through a slit or opening 540 in the outer circular wall 54, wherein any bursts of air A are directed through the nozzle 74 to force any excess seeds P″ back onto the seed holder 57, thereby singulating the seeds.

Preferably an ultrasonic sensor 80 is provided to measure the average height of the seed PP on top of the seed holder 57. A low/high threshold may be configured to support different sizes of seed and determine when the conveyor system 17 needs to supply more seed P from the hopper 12 to the planting unit 40.

In a preferred embodiment of the singulator 50, the flights 58 advance in the first direction D1 at a speed of 42 RPM, the seed holder 57 rotates at 50 RPM, the circular perimeter 54p has a 20 inch diameter, the circular perimeter 52p has an 18 inch diameter, and the distance or spacing 58s between each pair of flights 58 is 4.625 inches. This provides 10 sets of potato seeds per second to the seed discharge 42. Further in a preferred embodiment, the actuation of the pneumatic seed ejector 70 will be timed to the speed of the flights 58 so that air is delivered to the first (leading) half of the spacing 58s between the flights, to knock off any excess seeds, while air is stopped for the second (trailing) half of the spacing 58s.

The rotational speeds of the flights 58 may be adjusted to obtain a desired set of singulated potato seeds per second at the seed discharge 42. For example, for the preferred embodiment noted in the paragraph above, for a 1 set/sec, the flights 58 spins at approximately 4.2 RPM; for a 3 set/sec, the flights 58 spins at 12.8 RPM; for a 6 set/sec, the flights 58 spins at 25.7 RPM; for a 9 set/sec, the flights 58 spins at 38.5 RPM; and for a 12 set/sec, the flights 58 spins at 51.4 RPM. Preferably the seed holder 57 will continue to spin at 50 RPM to ensure that seeds are directed to the seed receiving area 59r from the seed bowl 60 in a centrifugal-like manner. Once processed by the singulator 50, individual seeds P exit the singulator 50 at a desired frequency and spacing so that the planting unit 40 accurately dispenses one seed and one seed only at a desired timing and frequency.

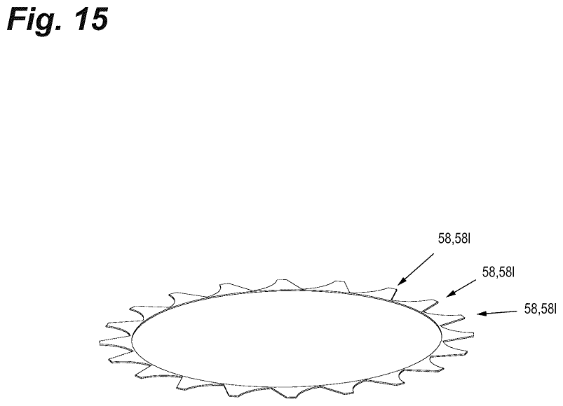

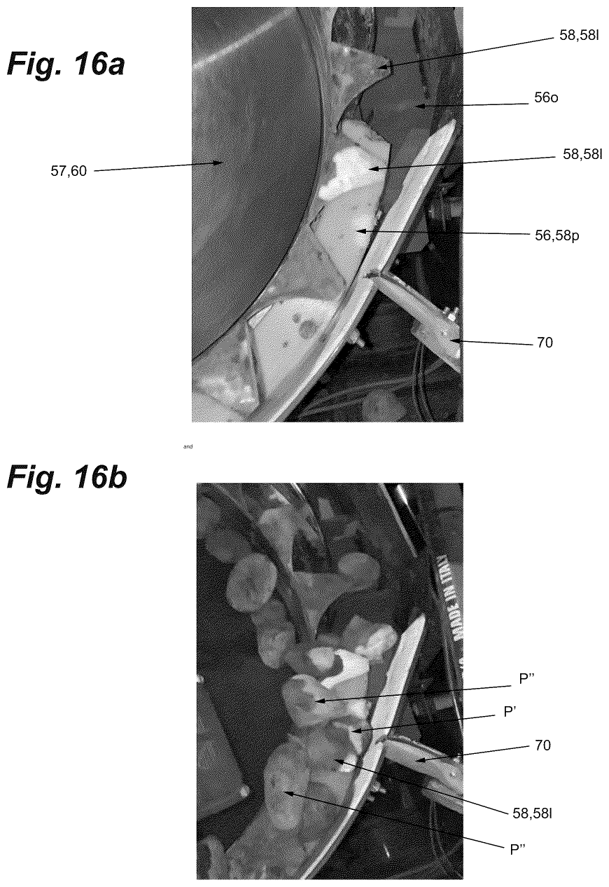

FIGS. 15 and 16a-16b illustrated another embodiment of the invention wherein the flights 58 comprise a triangular configuration and are raised a few centimeters above the seed singulating ledge 56, thereby creating pockets 58p to receive a singulated seed P′ and a support ledge 581 whereupon any excess seeds P″ will sit. Advantageously, singulated seeds P′ in the pocket 58p will be less likely to be knocked back into the seed bowl, while excess seeds P″ on supported by the ledge 581 are more easily removed therefrom by the seed ejector 70 and returned to the seed bowl 60.

Preferably, a first drive unit 44′ and a first linkage 46′ is provided to drive and power the continuous belt 43b of the delivery conveyor 43 in a conventional manner, a second drive unit 44″ and a second linkage 46″ is provided to drive and power the seed holder 46 in a conventional manner, and a third drive unit 44″ and a third linkage 46′″ is provided to drive and power the flights 48 (and any associated lower inner circular wall 52) in a conventional manner.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

1. A planting unit for singulating a plurality of seeds, said planting unit comprising:
a seed holder;
a seed discharge;
at least one drive unit;
a seed singulator;
wherein the seed singulator further comprises:
a seed singulating ledge; and
an excess seed ejector to eject any excess seeds from the seed singulating ledge onto the seed holder.

2. The planting unit of claim 1 wherein the seed singulating ledge has a ledge axis; and
wherein during operation of the planting unit the ledge axis is maintained substantially along the horizontal plane.

3. The planting unit of claim 2 wherein the seed singulator further comprises:
an open top;
a stepped bowl configuration having a lower inner circular wall and an upper outer circular wall; and
wherein the seed singulating ledge is positioned between said lower inner circular wall and an upper outer circular wall.

4. The planting unit of claim 3 wherein the seed holder is a substantially circular member positioned within the lower inner circular wall; and
wherein the lower inner circular wall, the upper outer circular wall, the seed singulating ledge and the seed holder cooperate to form a seed bowl.

5. The planting unit of claim 4 wherein the lower inner circular wall, the upper outer circular wall and the bottom seed holder may move relative to each other

6. The planting unit of claim 5 wherein seed singulating ledge further comprises a seed receiving area and a seed singulation area.

7. The planting unit of claim 6 wherein the seed singulator further comprises a plurality of flights positioned above the seed singulating ledge; and
wherein the inner circular wall and the flights are driven along the first direction by the at least one drive unit.

8. The planting unit of claim 7 wherein the plurality of flights are mounted to, and moveable with, the inner circular wall.

9. The planting unit of claim 8 wherein, during operation, the plurality of flights advances one or more of the plurality of seeds from the seed receiving area to the seed singulation area; and
wherein the seeds are singulated at said seed singlation area by the excess seed ejector.

10. The planting unit of claim 9 further comprising a seed discharge opening; and
wherein, during operation, the plurality of flights advance singulated seed to exit out of said seed discharge opening and into an entrance of the seed discharge.

11. The planting unit of claim 10 wherein the seed holder is angled relative to the lower inner circular wall and an upper outer circular wall, to provide a lowered portion of the seed holder adjacent the seed singulation area and a raised portion of the seed holder adjacent the seed receiving area.
